(19) United States
(12) Patent Application Publication
(10) Pub. No.: US 2015/0343965 A1
(43) Pub. Date: Dec. 3, 2015

(54) TRUCK CAB LINER WITH NOISE ABSORBER

(71) Applicant: FORD GLOBAL TECHNOLOGIES, LLC, Dearborn, MI (US)

(72) Inventor: Jeffrey R. Rowland, Brighton, MI (US)

(73) Assignee: FORD GLOBAL TECHNOLOGIES, LLC, Dearborn, MI (US)

(21) Appl. No.: 14/293,295

(22) Filed: Jun. 2, 2014

(51) Int. Cl. B60R 13/08; B60H 1/24; B60R 13/02

(52) U.S. Cl. CPC B60R 13/0884; B60R 13/02; B60H 1/249; B60R 2013/0287

(57) ABSTRACT

A body for a vehicle, such as a pickup truck, has a passenger cabin including an exterior body panel with an air extractor aperture and an interior trim panel. The trim panel is a liner mounted to the body panel thereby defining a generally-planar laterally extending chamber between them. The trim panel, which may be made of a sound absorbing material, has an air passage fluidically coupling the chamber with the passenger cabin. The air passage is laterally separated from a footprint region of the trim panel which is aligned with the air extractor aperture. The footprint region has an undulating surface facing the air extractor aperture to attenuate noise that enters the chamber through the air extractor aperture. The undulating surface may have an egg crate shape.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to air extractor systems for vehicle cabins, and, more specifically, to reducing outside noise propagation into the vehicle cabin through an air extractor.

It is well known to provide a mechanism for equalizing the pressure between the interior passenger compartment or cabin of the automobile and the atmosphere. To achieve good heating and air conditioning performance in a vehicle and to protect the interior compartment of the vehicle from moisture and outside debris, the passenger compartment of the vehicle is substantially sealed from the outside atmosphere. The sealing of the cabin, however, can result in the air pressure in the cabin exceeding the atmospheric pressure during the closing of a vehicle door or when operating an air blower at high speed. If the interior is not vented to the atmosphere, then the effort required to close the door may greatly increase, the ability to intake fresh air may be inhibited, and/or passenger discomfort may result from the high pressure.

A device known as an air extractor is commonly used to selectably open an airflow path from the vehicle passenger cabin to the external atmosphere. The air extractor typically includes a flap valve that responds to the difference between the internal and external pressures so that the flap opens to exhaust pressurized air from the cabin and then automatically closes when the internal pressure has diminished. Since the flap valve is only open when excessive pressure is present, it is normally closed. While closed, it prevents ingress of moisture, debris, and noise into the interior of the vehicle.

When the air extractor flaps are open, exterior sounds such as road and wind noise may propagate into the passenger cabin to the discomfort of the passengers. In addition, the closing of the flaps may create an additional sound which can be audible to the occupants.

The location for installing an air extractor valve depends on many factors including the body style of any particular vehicle. In sedans and sport utility vehicles, the air extractors are typically placed in a trunk, wheel well, or a rear bumper fascia. In these instances, a duct or tube may extend from the passenger cabin to the remote location where the air extractor actually vents to outside atmosphere. Due to the remote location and the length of the tube, noise may become sufficiently attenuated before entering the cabin. In a pickup truck, however, the air extractors are typically located between the truck cab and the truck bed, (i.e., at a location close to the passengers). A pickup truck typically employs a stamped sheet-metal exterior body wall (e.g., beneath a rear window) with one or more air extractor apertures piercing the wall. Closely spaced from the sheet-metal wall and parallel to it is an interior trim panel or liner which provides a visible back wall of the passenger compartment. A generally-planar chamber or air space is created between the wall and liner. An air passage or opening is provided in the liner as a spot laterally separated from the air extractor apertures to fluidically couple the inside of the passenger cabin to the chamber. The lateral separation of the openings from the air extractors prevents any exterior noise that enters the air extractors from directly passing into the passenger cabin. Instead, the noise would have to either penetrate the liner or spread laterally to reach the opening. To further reduce each of the mechanisms, the liner is typically comprised of a sound absorbing material. Nevertheless, it would be desirable to further decrease noise propagation via the air extractors.

### SUMMARY OF THE INVENTION

In one aspect of the invention, a vehicle body with a passenger cabin comprises an exterior body panel with an air extractor aperture and an interior trim panel. The trim panel is a liner mounted to the body panel defining a generally-planar laterally extending chamber. The trim panel has an air passage fluidically coupling the chamber with the passenger cabin. The air passage is laterally separated from a footprint region of the trim panel which is aligned with the air extractor aperture. The footprint region has an undulating surface facing the air extractor aperture to attenuate noise that enters the chamber through the air extractor aperture.

### BRIEF DESCRIPTION OF THE DRAWINGS

FIG. 1 is a diagram showing air flow through a truck cabin.

FIG. 2 is a top cross-sectional view showing air flow through a chamber formed by an interior trim liner and an exterior body panel.

FIG. 3 is a rear, plan view of a first embodiment of a trim liner.

FIG. 4 is a rear, plan view of a second embodiment of a trim liner.

FIG. 5 is a rear, perspective view of the trim liner of FIG. 3.

FIGS. 6A and 6B are vertical cross sections of the trim liner of FIG. 3.

FIG. 7 is a rear, plan view of a first embodiment of an exterior body panel.

FIG. 8 is a front, plan view of an air extractor.

FIG. 9 is a rear, plan view of the air extractor of FIG. 8.

FIG. 10 is an exploded view showing a wall assembly of the invention.

FIG. 11 is a rear, plan view of a trim liner showing a footprint of the air extractor and sound dispersion along the trim liner.

### DETAILED DESCRIPTION OF PREFERRED EMBODIMENTS

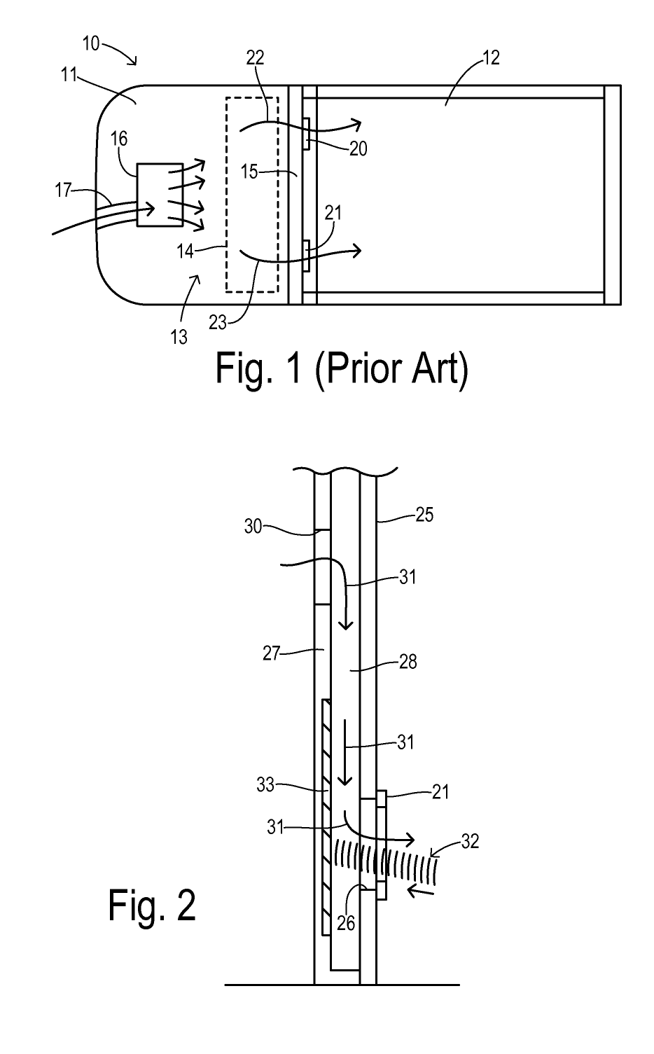

Referring to FIG. 1, a pickup truck 10 includes a cab section 11 and a bed section 12, wherein section 11 includes a passenger compartment 13 with a seating area 14. A compound wall 15 separates passenger compartment 13 from bed section 12. Truck 10 includes a heating, ventilating, and air-conditioning HVAC system 16 with a fresh air inlet 17. Outside air is drawn into HVAC 16 and distributed within passenger compartment 13. Wall 15 includes a pair of air extractors 20 and 21 to vent air from passenger compartment 13 along flow paths 22 and 23 in a conventional manner.

Composite wall 15 is shown in greater detail in FIG. 2, wherein an exterior body panel 25 is a stamped sheet metal wall providing a structural outer surface for the truck passenger cabin (e.g., below the rear window). Body panel 25 has an air extractor aperture 26 onto which air extractor unit 21 is mounted. An interior trim panel liner 27 is mounted to body panel 25 in a partially spaced-apart manner to create a chamber 28 between them. Chamber 28 is generally planar and extends laterally across the back of the passenger cabin. Among other things, chamber 28 provides sound and temperature insulating properties.

Trim panel liner 27 includes an air passage 30 that fluidically couples chamber 28 with the air space in the passenger cabin. Likewise, chamber 28 is coupled to external atmosphere via air extractor aperture 26 and extractor 21 (e.g., when extractor 21 is open). When the difference between the air pressure in the passenger cabin and external atmosphere is greater than a threshold, flaps (not shown) of extractor 21 open and an airflow along lines 31 vents the passenger cabin. When air extractor 21 is open, however, external noises or sounds 32 can propagate into the passenger cabin through air extractor 21 to impinge against liner 27 and to potentially emerge from air passage 30.

The present invention obtains a reduction in cabin noise (i.e., an increase in noise absorption) by introducing an undulating surface feature in a footprint region 33 that is aligned with air extractor aperture 26. The undulating surface is formed by a sound absorbing material and is configured to attenuate noise that enters chamber 28 through aperture 26.

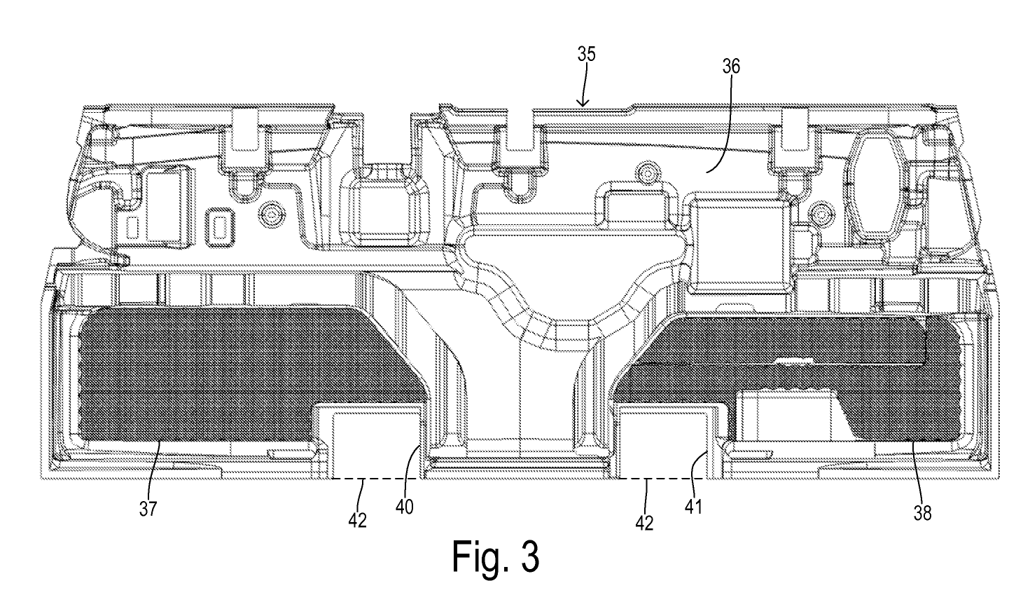

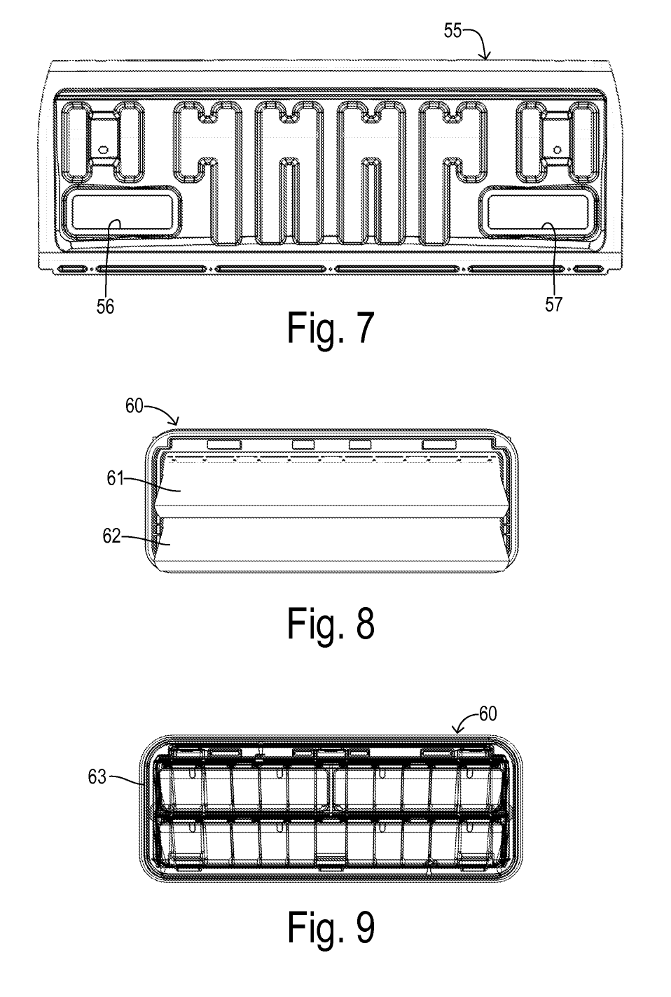

FIG. 3 shows a rear plan review of a trim panel liner 35 with a rear side surface 36. Surface 36 includes undulating surfaces 37 and 38 arranged to occupy footprint regions that are aligned with corresponding air extractor apertures in a body panel (shown in FIG. 7). Trim panel liner 35 is preferably comprised of a sound absorbing material such as a polyurethane foam commonly used in automotive interior trim panels. Liner 35 is molded with various features for attaching to the exterior body panels and for accommodating various features in the passenger cabin. In particular, air passages 40 and 41 are formed in liner 35 to create an opening above a floor line 42, thereby allowing air in the passenger cabin to pass behind liner 35 and to reach the air extractors. A duct or tube (not shown) may optionally be used to convey air between passages 40 and 41 and a desirable location in the passenger cabin in order to ensure that a flow path remains unblocked.

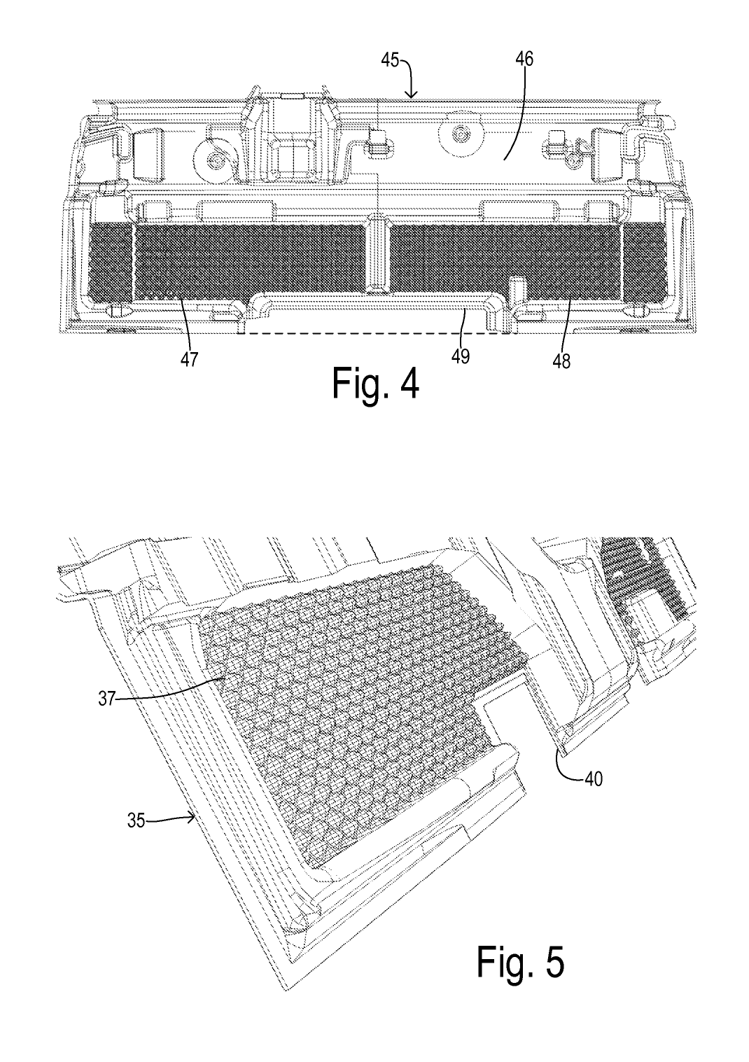

FIG. 4 shows an alternative embodiment for a liner 45 having a rear surface 46 with undulating surfaces 47 and 48 configured to be aligned with air extractor apertures in a matching exterior body panel. An air passage 49 is shown with a lower but wider profile as compared with openings 40 and 41, resulting in a similar flow cross-section to allow a sufficient airflow to the air extractors when needed.

FIG. 5 shows a perspective view of panel liner 35 showing undulating surface 37 in greater detail. In a preferred embodiment, undulating surface 37 includes an egg crate shape having a plurality of convex protrusions interspersed by a plurality of concave troughs. The protrusions and troughs as shown herein are smoothly curved to provide a constantly changing slope. Alternatively, other undulating shapes used for acoustic soundproofing such as pyramidal, truncated-pyramidal, or rippled shapes can be employed. As compared to a flat surface, the undulating surface of the present invention increases absorption of mid-frequency and high-frequency noises by increasing the total surface area and by breaking up sound reflection paths, for example.

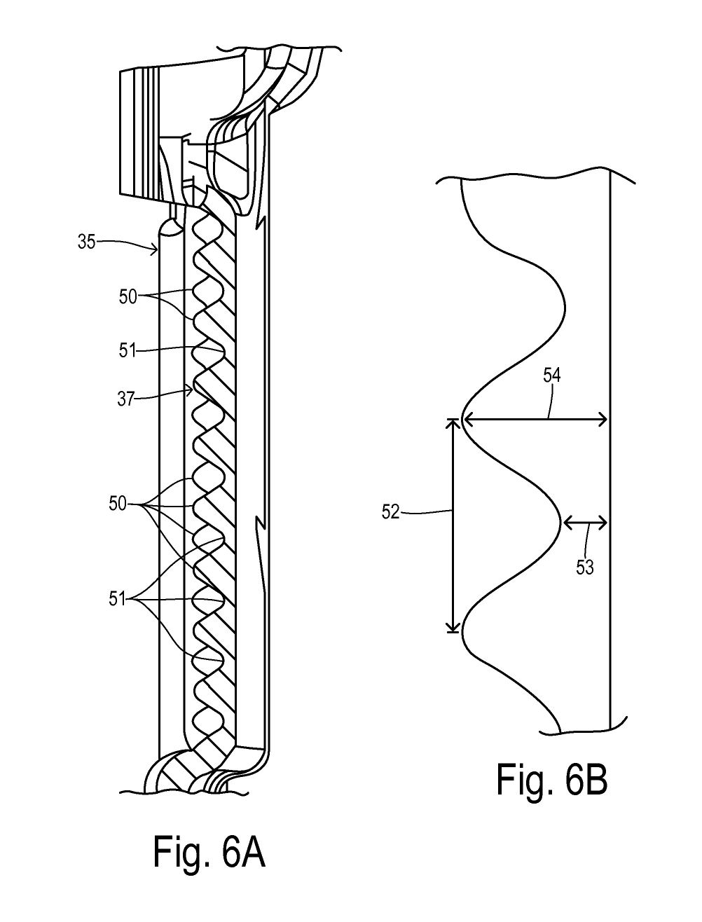

As shown in greater detail in FIG. 6A, the preferred egg crate shape for the undulating surface includes convex protrusions 50 interspersed with concave troughs 51. In this preferred embodiment, protrusions 50 and troughs 51 have a substantially constant peak-to-peak spacing 52 as shown in FIG. 6B which may preferably be in a range of about 10 mm to about 50 mm. In this regular repeating pattern, troughs 51 have a substantially constant spacing in the same range. The sound absorbing material of liner 35 preferably has a minimum thickness 53 at concave troughs 51 which is greater than about 3 mm (and more preferably greater than about 5 mm) Protrusions 50 define a maximum thickness 54 of liner 35 falling in the range from about 15 mm to about 25 mm. The egg-crate-shaped portion of liner 35 is preferably integrally formed with the other portions of liner 35 from the same molded polyurethane foam. Alternatively, a composite structure with a separate egg-crate-shaped sound absorbing layer bonded to the back surface of a larger liner can be used.

FIG. 7 shows a stamped sheet metal panel 55 forming the exterior body panel including air extractor apertures 56 and 57. Body panel 55 is assembled with other body panels and frame members to form the truck cab as known in the art.

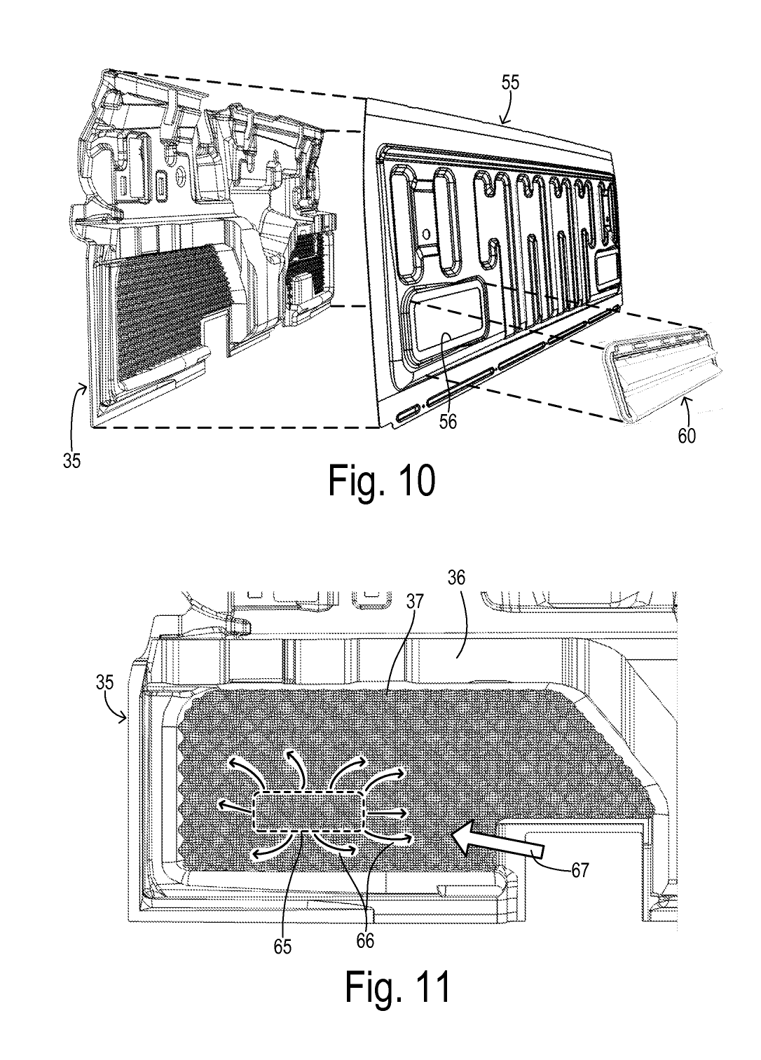

FIG. 8 is a front view of an air extractor 60 having a pair of movable flaps 61 and 62 configured to function as a flap valve to open when a predetermined pressure difference is present across flaps 61 and 62. As shown in FIG. 9, air extractor 60 has an outer flange 63 adapted for mounting air extractor 60 to the exterior body panel. The assembly of air extractor 60, body panel 55, and trim panel liner 35 is shown in FIG. 10.

As shown in FIG. 11, an outline of air extractor aperture 56 is projected onto liner 35 (i.e., aligned in the direction normal to panel 55 and liner 35) to define a footprint region 65. Undulating surface 37 coincides with footprint region 65, and may preferably extend laterally outside footprint region 65 so that a sound field spreading from footprint region 65 along lines 66 are greatly attenuated by the undulating, sound-absorbing surface. Thus, an airflow along air path 67 from the interior cabin to atmosphere is obtained with a sufficient flow capacity while limiting noise propagation into the cabin.

What is claimed is:

1. A vehicle body with a passenger cabin, comprising:
an exterior body panel with an air extractor aperture; and
an interior trim panel mounted to the body panel defining a generally-planar laterally extending chamber, wherein the trim panel has an air passage fluidically coupling the chamber with the passenger cabin, wherein the air passage is laterally separated from a footprint region of the trim panel which is aligned with the air extractor aperture, and wherein the footprint region has an undulating surface facing the air extractor aperture to attenuate noise that enters the chamber through the air extractor aperture.

2. The vehicle body of claim 1 wherein the undulating surface includes an egg crate shape.

3. The vehicle body of claim 2 wherein the egg crate shape includes a plurality of convex protrusions interspersed by a plurality of concave troughs, wherein the protrusions have a peak-to-peak spacing in the range of about 10 mm to about 50 mm.

4. The vehicle body of claim 3 wherein the troughs provide a minimum thickness of the trim panel greater than about 3 mm.

5. The vehicle body of claim 3 wherein the troughs provide a minimum thickness of the trim panel greater than about 5 mm and the protrusions provide a maximum thickness in a range of about 15 mm to about 25 mm.

6. The vehicle body of claim 1 wherein the undulating surface extends laterally outside the footprint region.

7. The vehicle body of claim 1 wherein the interior trim panel is comprised of molded polyurethane foam.

8. The vehicle body of claim 1 wherein the exterior body panel is comprised of stamped sheet metal.

9. The vehicle body of claim 1 further comprising an extractor cover mounted over the air extractor aperture and comprising a valve member configured to open in response to an air pressure in the passenger cabin.

10. The vehicle body of claim 1 wherein the exterior body panel is an outer wall of a pickup truck cab and wherein the interior trim panel is a trim liner at an edge of a seating area in the pickup truck cab.

11. Air extractor system for a vehicle cabin, comprising:
an exterior body panel with a first planar section having an extractor aperture; and
a trim liner with a second planar section parallel to the first planar section behind the extractor aperture defining an air passage between the body panel and trim liner to vent the cabin, wherein the second planar section has an undulating surface to attenuate noise entering the passage through the extractor aperture.

12. The system of claim 11 wherein the undulating surface includes an egg crate shape.

13. The system of claim 12 wherein the egg crate shape includes a plurality of convex protrusions interspersed by a plurality of concave troughs, wherein the protrusions have a peak-to-peak spacing in the range of about 10 mm to about 50 mm.

14. The system of claim 13 wherein the troughs provide a minimum thickness of the trim liner greater than about 3 mm.

15. The system of claim 13 wherein the troughs provide a minimum thickness of the trim liner greater than about 5 mm and the protrusions provide a maximum thickness in a range of about 15 mm to about 25 mm.
